(19) United States
(12) Patent Application Publication
(10) Pub. No.: US 2010/0055325 A1
(43) Pub. Date: Mar. 4, 2010

(54) INK SET FOR INKJET RECORDING AND INKJET IMAGE RECORDING METHOD

(75) Inventors: Minoru SAKAI, Kanagawa (JP); Kiyoshi IRITA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/540,386

(22) Filed: Aug. 13, 2009

(30) Foreign Application Priority Data
Aug. 28, 2008 (JP) 2008-219343

(51) Int. Cl. B05D 5/00; C09D 11/00

(52) U.S. Cl. 427/261; 106/31.13

(57) ABSTRACT

An ink set for inkjet recording includes: an ink composition having a surface tension of from 25 to less than 40 mN/m at 25° C.; and a reaction liquid having a surface tension of 40 mN/m or more at 25° C. and including an organic acid and a water-soluble organic solvent that is present at a content ratio of 0.15 to 0.70 relative to the organic acid. The reaction liquid coagulates the ink composition.

### CROSS-REFERENCE TO RELATED APPLICATION

This Application claims priority under 35 USC 119 from Japanese Patent Application No. 2008-219343 filed on Aug. 28, 2008, the disclosure of which is incorporated by reference herein.

### BACKGROUND OF THE INVENTION

1. Field of Invention

The present invention relates to an ink set for inkjet recording and to an inkjet image recording method.

2. Description of the Related Art

As recording media for inkjet recording, various recording media have been studied and techniques capable of forming high quality images are in demand. Further, various kinds of ink materials for inks have been investigated from the viewpoints of waterproofness and light fastness, for example.

For example, for a colorant, which is one ingredient contained in a set of ink materials, pigments have generally been used and the pigments are used dispersed in a dispersion medium such as water. When using a pigment in dispersion form, the diameter of particles when dispersed, stability after dispersion, particle size uniformity, and jetting properties from a jetting head and the like are important considerations, and various studies have been conducted regarding techniques for improving these aspects.

However, when recording is performed on plain paper or the like, sufficient performance cannot always be obtained with respect to, for example, fixing property (for example, resistance to rubbing) or resolution, in addition to color forming density. This is particularly the case when the speed of inkjet recording is increased, and a recording method more suitable for high speed recording using a single pass system capable of recording by one operation of a head, as opposed to a shuttle scanning system, is in demand.

An inkjet recording method that applies, to a recording medium, an ink composition having a specified value with respect to the ratio of surface tension to viscosity and which generates an aggregate when contacted with an aqueous composition, and an ink having a specified value with respect to the ratio of surface tension to viscosity, has been disclosed as a technique related to the above-described issues (see, for example, Japanese Patent Application Laid-Open (JP-A) No. 2004-10833).

### SUMMARY OF THE INVENTION

The present invention has been made in view of the above circumstances and provides an ink set for inkjet recording and an inkjet image recording method.

According to a first aspect of the invention, there is provided an ink set for inkjet recording including: an ink composition having a surface tension of from 25 to less than 40 mN/m at 25° C.; and a reaction liquid having a surface tension of 40 mN/m or more at 25° C. and containing an organic acid and a water-soluble organic solvent that is present at a content ratio of 0.15 to 0.70 relative to the organic acid.

According to a second aspect of the invention, there is provided an inkjet image recording method including: applying a reaction liquid having a surface tension of 40 mN/m or more at 25° C. and containing an organic acid and a water-soluble organic solvent that is present at a content ratio of 0.15 to 0.70 relative to the organic acid onto a recording medium; drying the reaction liquid; and jetting ink droplets of an ink composition having a surface tension of from 25 to less than 40 mN/m at 25° C. onto the recording medium onto which the reaction liquid has been applied, using an inkjet method.

### DETAILED DESCRIPTION OF THE INVENTION

However, in the inkjet recording method described in JP-A No. 2004-10833, the coagulating property of the ink is insufficient, and performance is also insufficient with respect to blank portion gloss, spotting interference and image scratch resistance.

<Ink set for inkjet Recording>

The ink set for inkjet recording of the present invention includes at least one kind of ink composition having a surface tension of from 25 mN/m to less than 40 mN/m at 25° C. and at least one kind of reaction liquid that coagulates the ink composition, which includes an organic acid and a water-soluble organic solvent that is present in a content ratio of 0.15 to 0.70 (mass standard) relative to the organic acid, and has a surface tension of 40 mN/m or more at 25° C.

Use of an ink set composed thus enables formation of an image having superior blank portion gloss in a non-image portion and superior scratch resistance, and suppressed spotting interference of the ink.

(Reaction Liquid)

The ink set of the present invention includes at least one kind of reaction liquid. The reaction liquid of the present invention causes the ink composition to coagulate upon contact therewith. As a result, it is possible to increase the speed of inkjet recording and to form images at high density and resolution even in higher speed recording.

The reaction liquid of the present invention includes an organic acid and a water-soluble organic solvent, and may also include water, a surfactant and/or other additives as necessary.

—Organic Acid—

The reaction liquid of the present invention includes at least one kind of organic acid. The organic acid is included in the reaction liquid as a coagulation component that causes coagulation of the ink composition.

The organic acid is not particularly limited as long as it is an organic compound having at least one kind of acidic group. Examples of the acidic group include a phosphoric group, a phosphonic group, a phosphinic group, a sulfuric group, a sulfonic group, a sulfinic group and a carboxyl group. The acidic group of the present invention is preferably a phosphoric group or a carboxyl group in view of the speed of coagulation of the ink composition, and is more preferably a carboxyl group.

The organic compound having a carboxyl group (organic carboxylic acid) is preferably selected from polyacrylic acid, acetic acid, glycolic acid, malonic acid, malic acid, maleic acid, ascorbic acid, succinic acid, glutaric acid, fumaric acid, citric acid, tartaric acid, phthalic acid, 4-methylphthalic acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumalic acid, thiophene carboxylic acid, nicotinic acid, or derivatives of these compounds or salts thereof (for example, polyvalent metal salts). One kind of these compounds may be used alone or two or more kinds of these compounds may be used together.

The organic carboxylic acid of the present invention is preferably a divalent or higher polyvalent carboxylic acid in view of the speed of coagulation of the ink composition, is more preferably at least one kind selected from malonic acid, malic acid, maleic acid, succinic acid, glutaric acid, fumaric acid, tartaric acid, 4-methylphthalic acid and citric acid, and is still more preferably at least one kind selected from malonic acid, malic acid, maleic acid, tartaric acid and 4-methylphthalic acid.

The content ratio of the organic acid in the reaction liquid is not particularly limited; however, in view of the speed of coagulation of the ink composition, the content ratio is preferably from 10 to 35 mass % and more preferably from 15 to 30 mass %.

Further, in view of the speed of coagulation of the ink composition, the reaction liquid preferably includes from 10 to 35 mass % of an organic carboxylic acid, more preferably includes from 15 to 30 mass % of an organic carboxylic acid, still more preferably includes from 10 to 35 mass % of a divalent or higher polyvalent carboxylic acid, and even yet more preferably includes from 15 to 30 mass % of a divalent or higher polyvalent carboxylic acid.

The reaction liquid of the present invention includes an organic acid as a component that causes coagulation of the ink composition; however, the reaction liquid may further include another coagulant that can coagulate the ink composition. Examples of the other coagulant include polyvalent metal salts and polyallylamine.

Examples of polyvalent metal salts include alkaline earth metals from the second group of the periodic table (such as magnesium and calcium), transition metals from the third group of the periodic table (such as lanthanum), metals from the thirteenth group of the periodic table (such as aluminum), salts of lanthanides (such as neodymium), and polyallylamine and polyallylamine derivatives. Carboxylic acid salts (such as formates, acetates and benzoates), nitric acid salts, chloride salts and thiocyanate salts are preferable as salts of metals. Among these, calcium salts or magnesium salts of carboxylic acid (such as formic acid, acetic acid or benzoic acid), calcium salts or magnesium salts of nitric acid, calcium chloride, magnesium chloride and calcium salts or magnesium salts of thiocyanic acid are preferable.

The content of polyvalent metal salt in the reaction liquid can be, for example, from 1 to 10 mass %.

—Water-Soluble Organic Solvent—

The reaction liquid of the present invention includes at least one kind of water-soluble organic solvent. The content ratio of the water-soluble organic solvent relative to the organic acid is from 0.15 to 0.70 by mass standard, preferably from 0.20 to 0.60 and more preferably from 0.25 to 0.50.

When the content ratio of the water-soluble organic solvent relative to the organic acid is within this range, blank portion gloss and image scratch resistance are favorable, and spotting interference is suppressed. Further, the coating properties of the reaction liquid are favorable when the reaction liquid is applied by coating, and a uniform coating surface can be obtained.

The water-soluble organic solvent of the present invention is not particularly limited as long as it is an organic solvent of which at least 5 g dissolves in 100 g of water at 20° C. Specifically, water-soluble organic solvents that can be included in the ink composition described below can also be used in a similar manner in the reaction liquid. Among these, in view of suppression of curling, polyalkylene glycols or derivatives thereof are preferable, and at least one kind selected from diethylene glycol monoalkyl ether, triethylene glycol monoalkyl ether, dipropylene glycol, tripropylene glycol monoalkyl ether, polyoxypropylene glyceryl ether or polyoxyethylene polyoxypropylene glycol is more preferable.

The content ratio of the water-soluble organic solvent in the reaction liquid is not particularly limited as long as it is within the above range of the content ratio relative to the organic acid; however, in view of suppression of curling, the content is preferably from 3 to 20 mass % relative to the whole reaction liquid, and is more preferably from 5 to 15 mass %.

As a water-soluble organic solvent, the reaction liquid of the present invention preferably includes a polyalkylene glycol or a derivative thereof at a content ratio of from 0.15 to 0.70 relative to the organic acid and from 3 to 20 mass % relative to the whole reaction liquid, and more preferably includes a polyalkylene glycol or a derivative thereof at a content ratio of from 0.20 to 0.60 relative to the organic acid and from 5 to 15 mass % relative to the whole reaction liquid.

This composition more effectively improves curl suppression, blank portion gloss and scratch resistance, and reduces spotting interference.

—Surfactant—

The reaction liquid of the present invention preferably includes at least one kind of surfactant. The surfactant may be used as a surface-tension controller. Examples of surface-tension controller include nonionic surfactants, cationic surfactants, anionic surfactants and betaine surfactants.

Among these, nonionic surfactants and anionic surfactants are preferable in view of the speed of coagulation of the ink composition.

Regarding examples of the surfactant, preferable specific examples of a hydrocarbon surfactant include: anionic surfactants such as fatty acid salts, alkyl sulfate ester salts, alkyl benzene sulfonates, alkyl naphthalene sulfonates, dialkyl sulfosuccinates, alkyl phosphate ester salts, naphthalenesulfonic acid-formalin condensates and polyoxyethylene alkyl sulfate ester salts; and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkyl amine, glycerin fatty acid ester and oxyethylene oxypropylene block copolymer. SURFYNOLs (trade name; produced by Air Products & Chemicals, Inc.), which are acetylene-type polyoxyethylene oxide surfactants, are preferably used. Furthermore, amine oxide amphoteric surfactants, such as N,N-dimethyl-N-alkyl amine oxide, are preferable.

Materials described as surfactants on pages 37-38 of JP-A No. 59-157636 and in Research Disclosure No. 308119 (1989) may be used.

Further examples include fluorine (alkyl fluoride type) surfactants and silicone surfactants such as those described in JP-A Nos. 2003-322926, 2004-325707 and 2004-309806.

The amount of surfactant added to the reaction liquid is not particularly limited; however, an addition amount that results in the surface tension of the reaction liquid being at least 40 mN/m is preferable, an addition amount that results in a surface tension of from 40 to 60 mN/m is more preferable, and an addition amount that results in a surface tension of from 42 to 50 mN/m is still more preferable.

—Other Additives—

The reaction liquid of the present invention may be composed so as to include other additives in addition to the organic acid and the water-soluble organic solvent. The other additives in the reaction liquid are similar to the other additives in the ink composition described below.

The reaction liquid of the present invention has surface tension of at least 40 mN/m at 25° C., but the surface tension is preferably 40 to 60 mN/m, more preferably 42 to 50 mN/m and still more preferably 42 to 47 mN/m. When the surface tension of the reaction liquid is within this range, it is possible to more effectively suppress the occurrence of curling in a recording medium.

The surface tension of the reaction liquid may, for example, be adjusted by addition of a surfactant. Further, the surface tension of the reaction liquid is measured by a plate method at 25° C. using an Automatic Surface Tensionmeter CBVP-Z (manufactured by Kyowa Interface Science Co., Ltd.).

The reaction liquid of the present invention preferably has a pH (at 25° C.±1° C.) of 3.5 or less, more preferably 0.5 to 2.5, and still more preferably 0.5 to 2.0, in view of the coagulation speed of the ink composition.

The viscosity of the reaction liquid is preferably in the range of from 1 to 30 mPa·s, more preferably in the range of from 1 to 20 mPa·s, still more preferably in the range of from 2 to 15 mPa·s, and particularly preferably in the range of from 2 to 10 mPa·s, in view of the coagulation speed of the ink composition. Further, the viscosity is measured at 25° C. using a VISCOMETER TV-22 (manufactured by Toki Sangyo Co., Ltd.).

In view of the coagulation speed of the ink composition, blank portion gloss, spotting interference and image scratch resistance, the reaction liquid of the present invention preferably includes 10 to 35 mass % of a divalent or higher polyvalent carboxylic acid as an organic acid and a polyalkylene glycol or a derivative thereof at a content ratio of from 0.15 to 0.70 relative to the organic acid as a water-soluble organic solvent, and more preferably includes 15 to 30 mass % of a divalent or higher polyvalent carboxylic acid as an organic acid and a polyalkylene glycol or a derivative thereof at a content ratio of from 0.20 to 0.60 relative to the organic acid as a water-soluble organic solvent.

(Ink Composition)

The ink set for inkjet recording of the present invention includes at least one kind of ink composition, but preferably includes two or more kinds of ink composition. Further, the ink composition of the present invention has a surface tension of from 25 to less than 40 mN/m at 25° C., but preferably of from 27 to 37 mN/m. This results in favorable droplet jetting properties.

Further, as a result of the surface tension of the ink composition being lower than the surface tension of the reaction liquid, image scratch resistance is favorable and spotting interference is reduced.

In addition, the surface tension of the ink composition may, for example, be adjusted by including a surfactant. Further, the surface tension of the ink composition is measured in a similar manner to that of the reaction liquid.

The ink composition of the present invention may include water and at least one kind of color material, and may be composed so as to include a water-soluble organic solvent, a surfactant, polymer particles and other additives, as necessary.

The ink composition of the present invention includes water and the amount of water included is not particularly limited. The content amount of water in the present invention is preferably from 10 to 99 mass %, more preferably from 30 to 80 mass % and still more preferably from 50 to 70 mass %.

—Coloring Material—

The ink composition of the present invention includes at least one kind of coloring material. The coloring material is preferably a water-insoluble coloring material. Inclusion of a water-insoluble coloring material results in favorable ink coloring properties and enables recording of a visible image having favorable color density and hue.

A water-insoluble coloring material refers to a coloring material that hardly dissolves at all, or has poor solubility, in water and, specifically, refers to a coloring material of which 0.5 mass % or less dissolves in water at 25° C.

As the coloring material component of the water-insoluble coloring material, known dyes, pigments and the like may be used without particular limitation. Specific examples include all sorts of pigments, dispersive dyes, oil-soluble dyes and pigments that form J-aggregates, and pigments are more preferable.

In the present invention, a water-insoluble pigment itself or a water-insoluble pigment surface-treated with a dispersant may be included in the ink composition of the present invention as a water-insoluble coloring material.

The kind of pigment is not particularly limited, and any known organic pigment or known inorganic pigment may be used. Examples of the pigment include polycyclic pigments such as an azo lake, an azo pigment, a phthalocyanine pigment, a perylene pigment and a perynone pigment, an anthraquinone pigment, a quinacridone pigment, a dioxadine pigment, a diketopyrrolopyrrole pigment, a thioindigo pigment, an isoindoline pigment and a quinophthalone pigment; dye lakes such as basic dye type lakes and acidic dye type lakes; organic pigments such as a nitro pigment, a nitroso pigment, aniline black and a daylight fluorescent pigment; and inorganic pigments such as titanium oxide, iron oxide type and carbon black type. Even a pigment that is not described in the Color Index may be used so long as it is a pigment that can be dispersed in an aqueous phase. Furthermore, a pigment obtained by surface treating the above-described pigments with a surfactant, a polymeric dispersant or the like, or grafted carbon may also be used.

Among these pigments, an azo pigment, a phthalocyanine pigment, an anthraquinone pigment, a quinacridone pigment and a carbon black type pigment are preferable.

Specific examples of the organic pigment used in the invention include those described below.

Examples of organic pigments for orange or yellow include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, C.I. Pigment Yellow 138, C.I. Pigment Yellow 151, C.I. Pigment Yellow 155, C.I. Pigment Yellow 180 and C.I. Pigment Yellow 185.

Examples of organic pigments for magenta or red include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222 and C.I. Pigment Violet 19.

Examples of organic pigments for green or cyan include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Green 7, and siloxane-crosslinked aluminum phthalocyanine described in U.S. Pat. No. 4,311,775.

Examples of organic pigments for black include C.I. Pigment Black 1, C.I. Pigment Black 6 and C.I. Pigment Black 7.

˜Dispersant˜

When a pigment is included in the ink composition as a coloring material, the pigment is preferably dispersed in an aqueous solvent by a dispersant. The dispersant may be a polymer dispersant or a dispersant that is a low-molecular-weight surfactant. The polymer dispersant may be either a water-soluble dispersant or a water-insoluble dispersant.

The dispersant that is a low-molecular-weight surfactant (hereinafter also referred to as a “low-molecular-weight dispersant”) may be added for the purpose of stably dispersing the organic pigment in a water solvent while maintaining an ink at low viscosity. Here, the low-molecular-weight dispersant refers to a low-molecular-weight dispersant having a molecular weight of 2,000 or less. The molecular weight of the low-molecular-weight dispersant is preferably from 100 to 2,000, and more preferably from 200 to 2,000.

The low-molecular-weight dispersant has a structure containing a hydrophilic group and a hydrophobic group. The number of hydrophilic groups and the number of hydrophobic groups in one molecule may be independent and each may be 1 or more. The low-molecular-weight dispersant may have plural kinds of hydrophilic group and/or plural kinds of hydrophobic group. The low-molecular-weight dispersant may, as appropriate, contain a linking group that links the hydrophilic group and the hydrophobic group.

Examples of the hydrophilic group include an anionic group, a cationic group, a nonionic group, and a betaine group in which two or more of these groups are combined.

The anionic group is not particularly limited so long as it has a negative charge. A phosphoric acid group, a phosphonic acid group, a phosphinic acid group, a sulfuric acid group, a sulfonic acid group, a sulfinic acid group and a carboxyl group are preferred, a phosphoric acid group and carboxyl group are more preferred, and a carboxyl group is further preferred.

The cationic group is not particularly limited so long as it has a positive charge. An organic cationic substituent is preferred, a cationic group containing nitrogen or phosphorus is more preferred, and a cationic group having nitrogen is further preferred. Above all, pyridinium cation and ammonium cation are particularly preferred.

The nonionic group is not particularly limited so long as it does not have a negative or positive charge. Examples of the nonionic group include polyalkylene oxide, polyglycerin and a sugar unit of a certain kind.

In the invention, the hydrophilic group is preferably an anionic group in view of the dispersion stability and aggregation properties of a pigment.

When the low-molecular-weight dispersant has an anionic hydrophilic group, the pKa of the low-molecular-weight dispersant is preferably 3 or more in view of contacting with an acidic reaction liquid to accelerate an aggregation reaction. The pKa of a low-molecular-weight dispersant mentioned herein is a value experimentally obtained from a titration curve, by titrating a 1 mmol/L solution of the low-molecular-weight dispersant in a tetrahydrofuran-water=3:2 (V/V), using an acid or alkali aqueous solution.

Theoretically, when the pKa of a low molecular-weight dispersant is 3 or more, 50% or more of the anionic groups thereof are in a non-dissociated state when contacted with a reaction liquid having a pH of about 3. As a result, the water-solubility of the low-molecular-weight dispersant is significantly decreased, and an aggregation reaction occurs. In other words, aggregation reactivity is improved. From this standpoint, it is preferred that the low-molecular-weight dispersant has a carboxyl group as an anionic group.

On the other hand, the hydrophobic group may have, for example, a hydrocarbon structure, a fluorocarbon structure or a silicone structure, and preferably has a hydrocarbon structure. The hydrophobic group may have either a linear structure or a branched structure. The hydrophobic group may have a single-chain structure or a multi-chain structure having two or more chains, wherein the multi-chain structure may have plural kinds of hydrophobic group.

The hydrophobic group is preferably a hydrocarbon group having from 2 to 24 carbon atoms, more preferably a hydrocarbon group having from 4 to 24 carbon atoms, and further preferably a hydrocarbon group having from 6 to 20 carbon atoms.

Of the polymer dispersants, a hydrophilic polymer compound may be used as a water-soluble dispersant. Examples of natural hydrophilic polymer compounds include vegetable polymers such as gum Arabic, gum tragacanth, gum guar, gum karaya, locust bean gum, arabinogalactan, pectin and quince seed starch; seaweed polymers such as alginic acid, carrageenan and agar; animal polymers such as gelatin, casein, albumin and collagen; and microbial polymers such as xanthene gum and dextran.

Examples of chemically-modified hydrophilic polymer compounds obtained using a natural product as a raw material include cellulose polymers such as methyl cellulose, ethyl cellulose, hydroxyethyl cellulose, hydroxypropyl cellulose and carboxymethyl cellulose; starch polymers such as starch sodium glycolate and starch sodium phosphate ester; and seaweed polymers such as propylene glycol alginate ester.

Examples of synthetic hydrophilic polymer compounds include vinyl polymers such as polyvinyl alcohol, polyvinyl pyrrolidone and polyvinyl methyl ether; acrylic resins such as polyacrylamide, polyacrylic acid or an alkali metal salt thereof, and water-soluble styrene acrylic resin; water-soluble styrene maleic acid resins; water-soluble vinylnaphthalene acrylic resins; water-soluble vinylnaphthalene maleic resins; polyvinyl pyrrolidone, polyvinyl alcohol, alkali metal salts of formalin condensates of β-naphthalenesulfonic acid; and polymer compounds having a salt of a cationic functional group such as quaternary ammonium or amino group at a side chain thereof.

Among these, a polymer compound containing a carboxyl group is preferred in view of the dispersion stability and aggregation properties of pigment. Polymer compounds containing a carboxyl group are particularly preferable and examples thereof include acrylic resins such as water-soluble styrene acrylic resin; water-soluble styrene maleic resin; water-soluble vinylnaphthalene acrylic resin; and water-soluble vinylnaphthalene maleic acid resin.

Of the polymer dispersants, a polymer having both a hydrophilic moiety and a hydrophobic moiety may be used as a water-insoluble dispersant,. Examples of such a polymer include a styrene-(meth)acrylic acid copolymer, a styrene-(meth)acrylic acid-(meth)acrylic acid ester copolymer, a (meth)acrylic acid ester-(meth)acrylic acid copolymer, a polyethylene glycol (meth)acrylate-(meth)acrylic acid copolymer and a styrene-maleic acid copolymer.

“(Meth)acrylic acid” means acrylic acid or methacrylic acid. “(Meth)acrylate” means acrylate or methacrylate. Other (meth)acrylic derivatives also indicate acrylic or methacrylic derivatives.

The polymer dispersant may have a weight average molecular weight of preferably from 3,000 to 200,000, more preferably from 5,000 to 100,000, further preferably from 5,000 to 80,000, and particularly preferably from 10,000 to 60,000.

The mixing ratio of pigment to dispersant (pigment: dispersant) by mass is preferably in a range of from 1:0.06 to 1:3, more preferably in a range of from 1:0. 125 to 1:2, and further preferably in a range of from 1:0.125 to 1:1.5.

When a dye is used as a coloring material, a material in which a dye is retained on a water-insoluble carrier may be used as a water-insoluble coloring material. As the dye, conventional dyes may be used without particular limitation. For example, dyes described in JP-A Nos. 2001-115066, 2001-335714 and 2002-249677 may be suitably used in the invention. The carrier is not particularly limited so long as it is insoluble or hardly soluble in water, and inorganic materials, organic materials and composite materials thereof may be used. Specifically, carriers described in, for example, JP-A Nos. 2001-181549 and 2007-169418 may be used suitably in the invention.

The carrier supporting a dye (water-insoluble coloring material) can be used in the form of an aqueous dispersion using a dispersant. As the dispersant, any of the dispersants described above may be used suitably.

In view of lightfastness, quality and the like of an image, the coloring material preferably includes a pigment and a dispersant, more preferably includes an organic pigment and a polymer dispersant, and particularly preferably includes an organic pigment and a polymer dispersant including a carboxyl group. Among these, in view of aggregation properties and, by extension, ink fixing properties, a water-insoluble product of a coloring material (preferably a pigment) covered by a polymer dispersant (preferably including a carboxyl group) is preferable as the water-insoluble coloring material and, further, a water-insoluble product of a pigment covered by an acrylic polymer dispersant is preferable. Preferable examples of acrylic polymers include acrylic resins such as water-soluble styrene-acrylic resin, water-soluble styrene-maleic acid resin, water-soluble vinyl naphthalene-acrylic resin and water-soluble vinyl naphthalene-maleic acid resin.

Further, in view of aggregation properties, it is preferable that the acid value of the polymer dispersant is larger than the acid value of the polymer particles (preferably self-dispersing polymer particles) described below.

The coloring material preferably has an average particle diameter of from 10 to 200 nm, more preferably from 10 to 150 nm, and further preferably from 10 to 100 nm. When the average particle diameter is 200 nm or less, color reproducibility is favorable and, in the case of an inkjet method, droplet jetting properties are favorable. Further, when the average particle diameter is 10 nm or more, lightfastness is favorable. The particle size distribution of the coloring material is not particularly limited, and may be either a wide particle size distribution or a monodisperse particle size distribution. A mixture of two or more of coloring materials having monodisperse particle size distributions may be used.

The average particle diameter and the particle size distribution of the coloring material can be determined by measuring the volume average particle diameter using a dynamic light scattering method using a particle size distribution measuring apparatus NANOTRACK UPA-EX150 (manufactured by Nikkiso Co., Ltd.).

In view of image density, the content of the water-insoluble coloring material in the ink composition is preferably from 1 to 25 mass %, more preferably from 2 to 20 mass %, further preferably from 5 to 20 mass %, and particularly preferably from 5 to 15 mass %, based on the mass of the ink composition.

A single kind of, or a mixture of two or more kinds of, the water-insoluble coloring material may be used.

—Water-Soluble Organic Solvent—

The ink composition in the invention may contain water as a solvent and preferably further contains at least one water-soluble organic solvent. Since the ink composition includes a water-soluble organic solvent, drying may be prevented and permeation may be accelerated. When using the water-soluble organic solvent as a drying inhibitor, it is possible to effectively prevent clogging of nozzles which may be generated by drying of an ink at an ink jetting port when the ink composition is jetted by an inkjet method for image recording.

The water-soluble organic solvent is preferably a water-soluble organic solvent having a vapor pressure lower than that of water from the viewpoint of prevention of drying. Specific examples of the water-soluble organic solvent include polyhydric alcohols such as ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin and trimethylolpropane; lower alkyl ethers of polyhydric alcohol, such as ethylene glycol monomethyl (or ethyl) ether, diethylene glycol monomethyl (or ethyl) ether and triethylene glycol monoethyl (or butyl) ether; heterocycles such as 2-pyrrolidone, N-methyl-2-pyrrolidone, 1,3-dimethyl-2-imidazolidinone and N-ethylmorpholine; sulfur-containing compounds such as sulfolane, dimethylsufoxide and 3-sulforene; polyfunctional compounds such as diacetone alcohol and diethanolamine; and urea derivatives.

Among the water-soluble organic solvents, polyhydric alcohols such as glycerin and diethylene glycol are preferred. The water-soluble organic solvent may be used alone or in combination of two or more thereof. The water-soluble organic solvent may be contained in an amount of preferably from 10 to 50 mass % in the ink composition.

In order to accelerate permeation, a water-soluble organic solvent is preferably used for the purpose of causing more favorable permeation of the ink composition into a recording medium. Specific examples of the water-soluble organic solvent which may be preferably used for accelerating permeation include alcohols such as ethanol, isopropanol, butanol, di(or tri)ethylene glycol monobutyl ether and 1,2-hexanediol; sodium lauryl sulafate, sodium oleate and nonionic surfactants. When the content of the water-soluble organic solvent in the ink composition is from 5 to 30 mass %, a sufficient effect may be produced. The water-soluble organic solvent is preferably used within such a range of addition amount that bleeding of print or image and print-through are do not occur.

The water-soluble organic solvent may be used other purposed than the above, and may be used to adjust viscosity. Specific examples of water-soluble organic solvents that can be used to adjust viscosity include alcohols (for example, methanol, ethanol, propanol, isopropanol, butanol, isobutanol, sec-butanol, t-butanol, pentanol, hexanol, cyclohexanol and benzyl alcohol), polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol and thiodiglycol), glycol derivatives (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether and ethylene glycol monophenyl ether), amines (for example, ethanolamine, diethanolamine, triethanolamine, N-methyl diethanolamine, N-ethyl diethanolamine, morpholine, N-ethylmorpholine, ethylene diamine, diethylene triamine, triethylene tetramine, polyethylene imine and tetramethylpropylene diamine), and other polar solvents (for example, formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile and acetone).

The water-soluble organic solvent may be used alone or in the form of a mixture of two or more thereof.

—Surfactant—

The ink composition of the present invention preferably includes at least one kind of surfactant. The surfactant is used as a surface-tension controller. Examples of the surface-tension controller include nonionic surfactants, cationic surfactants, anionic surfactants and betaine surfactants. In the present invention, anionic surfactants or nonionic surfactants are preferable in view of the speed of coagulation, and anionic surfactants are more preferable.

In order for the ink composition to be jetted satisfactorily in an inkjet method, the surfactant may be contained in such an amount that the surface tension of the ink composition is adjusted to be preferably from 25 to less than 40 mN/m. The content of the surfactant is more preferably an amount capable of adjusting the surface tension to be from 27 to 37 mN/m.

When the surfactant is a hydrocarbon surfactant, preferable specific examples thereof include anionic surfactants such as fatty acid salts, alkyl sulfate ester salts, alkyl benzene sulfonates, alkyl naphthalene sulfonates, dialkyl sulfosuccinates, alkyl phosphate ester salts, naphthalenesulfonic acid-formalin condensates and polyoxyethylene alkyl sulfate ester salts; and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkyl amine, glycerin fatty acid ester and oxyethylene oxypropylene block copolymer. SURFYNOLs (trade name; products of Air Products & Chemicals, Inc.), which are acetylene type polyoxyethylene oxide surfactants, are preferably used. Furthermore, amine oxide amphoteric surfactants, such as N,N-dimethyl-N-alkyl amine oxide, are preferred.

The materials described as surfactants on pages 37 to 38 of JP-A No. 59-157636 and in Research Disclosure No. 308119 (1989) may be used.

Further examples include fluorine (alkyl fluoride type) surfactants, silicone surfactants and the like, such as those described in JP-A Nos. 2003-322926, 2004-325707 and 2004-309806, which can also improve resistance to rubbing.

The surface-tension controller may be used as an anti-foam agent, such as a fluorinated compound, a silicone compound, or a chelating agent (EDTA, for example).

—Polymer Particles—

The ink composition in the present invention preferably includes at least one kind of polymer particle, which results in more effective improvement of scratch resistance of images formed thereby.

Examples of the polymer particles of the present invention include particles of resins having an anionic group such as thermoplastic, thermosetting or modified acrylic, epoxy, polyurethane, polyether, polyamide, unsaturated polyester, phenolic, silicone or fluorine resins, polyvinyl resins such as polyvinyl chloride, polyvinyl acetate, polyvinyl alcohol or polyvinyl butyral, polyester resins such as alkyd resin or phthalic acid resin, amino materials such as melamine resin, melamine formaldehyde resin, aminoalkyd co-condensed resin, urea resin or urea-formaldehyde resin, or copolymers or mixtures thereof. Among these, an anionic acrylic resin can, for example, be obtained by polymerizing, in a solvent, an acrylic monomer having an anionic group (an anionic group-containing acrylic monomer) and, as necessary, another monomer that is copolymerizable with the anionic group-containing acrylic monomer. Examples of the anionic group-containing acrylic monomer include acrylic monomers having one or more selected from the group consisting of a carboxyl group, a sulfonic acid group and a phosphonic acid group and, among these, acrylic monomers having a carboxyl group are preferable (such as acrylic acid, methacrylic acid, crotonic acid, ethacrylic acid, propylacrylic acid, isopropylacrylic acid, itaconic acid and fumaric acid), and acrylic acid and methacrylic acid are particularly preferable.

As the polymer particles in the invention, self-dispersing polymer particles are preferred and self-dispersing polymer particles having a carboxyl group are more preferred, in view of jetting stability and liquid stability (in particular, dispersion stability) when using the above coloring material (in particular, a pigment). The self-dispersing polymer particles are particles of a water-insoluble polymer that does not contain a free emulsifier and that can get into a dispersed state in an aqueous medium, even in the absence of other surfactants, due to a functional group (in particular, an acidic group or a salt thereof) which the polymer itself has.

The dispersed state may be an emulsified state in which the water-insoluble polymer is dispersed in a liquid state in an aqueous medium (emulsion) or a state in which the water-insoluble polymer is dispersed in a solid state in the aqueous medium (suspension).

The water-insoluble polymer of the invention is preferably a water-insoluble polymer that can go into a dispersed state in which the water-insoluble polymer is dispersed in a solid state, in view of the aggregation speed and the fixing property of an ink composition containing the water-insoluble polymer.

The following procedure can be used to determine whether a water-insoluble polymer is a self-dispersing polymer as mentioned herein: 30 g of a water-insoluble polymer is dissolved into 70 g of an organic solvent (for example, methyl ethyl ketone) to form a solution, the solution is mixed with 200 g of water and a neutralizing agent capable of neutralizing salt-forming groups of the water-insoluble polymer to a degree of 100% (the neutralizing agent being sodium hydroxide when the salt forming group is anionic or acetic acid when the group is cationic), the mixture is stirred with a stirrer equipped with a stirring blade at rotation rate of 200 rpm at 25° C. for 30 minutes, and the organic solvent is removed from the mixture liquid. If a stable dispersion state of the water-insoluble polymer in the mixture liquid at 25° C. is confirmed by visual observation for at least one week, the water-insoluble polymer is considered to be a self-dispersing polymer.

Further, the water-insoluble polymer refers to a polymer showing a solubility of 10 g or less when the polymer is dried at 105° C. for 2 hours and then dissolved in 100 g of water at 25° C. The solubility is preferably 5 g or less, and more preferably 1 g or less. The solubility mentioned above is a value measured when the polymer is neutralized with sodium hydroxide or acetic acid to a degree of 100% in accordance with the kind of the salt-forming groups of the water-insoluble polymer.

The aqueous medium contains water and optionally contains a hydrophilic organic solvent. In the invention, the aqueous medium preferably includes water and a hydrophilic organic solvent in an amount of 0.2 mass % or less relative to water, and, more preferably, the aqueous medium consists of water only.

The main chain backbone of the water-insoluble polymer is not particularly limited and, for example, a vinyl polymer or a condensation polymer (such as an epoxy resin, polyester, polyurethane, polyamide, cellulose, polyether, polyurea, polyimide or polycarbonate) may be used. Among these, a vinyl polymer is particularly preferred.

Preferred examples of the vinyl polymer and the monomer or monomers for forming the vinyl polymer include those described in JP-A Nos. 2001-181549 and 2002-88294. Further, a vinyl polymer in which a dissociative group is introduced to a terminal of the polymer chain by radical polymerization of a vinyl monomer using a chain transfer agent, polymerization initiator, or iniferter having the dissociative group (or a substituent that can be converted to the dissociative group), or by ionic polymerization using an initiator or terminator that is a compound having the dissociative group (or a substituent that can be converted to the dissociative group), may be used.

Preferred examples of the condensation polymer and monomers for forming the condensation polymer include those described in JP-A No. 2001-247787.

The self-dispersing polymer particles in the invention preferably contain a water-insoluble polymer containing a hydrophilic structural unit and a hydrophobic structural unit, in view of self-dispersibility. The hydrophobic structural unit is preferably derived from an aromatic group-containing monomer. The expression “. . . structural unit . . . derived from . . . (A)” used herein means a component in a polymer which component is formed by the binding of (A) to an adjacent structural unit or units.

The hydrophilic structural unit is not particularly limited so long as it is derived from a hydrophilic group-containing monomer. The water-insoluble polymer may include structural units derived from one kind of hydrophilic group-containing monomer or structural units derived from two or more kinds of hydrophilic group-containing monomer. The hydrophilic group is not particularly limited, and it may be either a dissociative group or a nonionic hydrophilic group.

In the invention, the hydrophilic group is preferably a dissociative group, and more preferably an anionic dissociative group, in view of promoting self-dispersibility and in view of the stability of the obtained emulsion or dispersion state. Examples of the dissociative group include a carboxyl group, a phosphoric acid group, and a sulfonic acid group and, among these, a carboxyl group is preferred in view of fixability of the ink composition containing the self-dispersing polymer particles.

The hydrophilic group-containing monomer in the invention is preferably a dissociative group-containing monomer, and more preferably a dissociative group-containing monomer having a dissociative group and an ethylenically unsaturated bond, in view of self-dispersibility and aggregation properties.

Examples of the dissociative group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxymethylsuccinic acid. Specific examples of the unsaturated sulfonic acid monomer include styrenesulfonic acid, 2-acrylamide-2-methylpropane sulfonic acid, 3-sulfopropyl (meth)acrylate, and bis(3-sulfopropyl) itaconate. Specific examples of the unsaturated phosphoric acid monomer include vinyl phosphonic acid, vinyl phosphate, bis(methacryloyloxyethyl) phosphate, diphenyl-2-acryloyloxyethyl phosphate, diphenyl-2-methacryloyloxyethyl phosphate, and dibutyl-2-acryloyloxyethyl phosphate.

Among the dissociative group-containing monomers, unsaturated carboxylic acid monomers are preferred, and acrylic acid and methacrylic acid are more preferred, in view of dispersion stability and jetting stability.

The self-dispersing polymer particles in the invention preferably contain a polymer having a carboxyl group and, more preferably, contain a polymer having a carboxyl group and an acid value (mgKOH/g) of from 25 to 100, in view of self-dispersibility and the aggregation speed at the time the ink composition containing the polymer particles contacts with the reaction liquid. The acid value is more preferably from 25 to 80, and particularly preferably from 30 to 65, in view of self-dispersibility and the aggregation speed at the time the ink composition containing the polymer particles contacts with the reaction liquid.

Specifically, when the acid value is 25 or more, the stability of the self-dispersibility may be more favorable, and when the acid value is 100 or less, aggregation property may be improved.

The aromatic group-containing monomer is not particularly limited so long as it is a compound containing an aromatic group and a polymerizable group. The aromatic group may be either a group derived from an aromatic hydrocarbon or a group derived from an aromatic heterocyclic ring. In the invention, the aromatic group is preferably an aromatic group derived from an aromatic hydrocarbon, in view of the shape stability of the particles in an aqueous medium. The expression “group derived from an aromatic hydrocarbon or a group derived from an aromatic heterocyclic ring” used herein means a group formed by removing at least one hydrogen atom from an aromatic hydrocarbon or from an aromatic heterocyclic ring.

The polymerizable group may be either a condensation-polymerizable group or an addition-polymerizable group. In the invention, the polymerizable group is preferably an addition-polymerizable group, and more preferably a group containing an ethylenically unsaturated bond, in view of the shape stability of the particles in an aqueous medium.

The aromatic group-containing monomer in the invention is preferably a monomer having an aromatic group derived from an aromatic hydrocarbon and an ethylenically unsaturated bond. The aromatic group-containing monomer may be used singly or in combination of two or more kinds thereof.

Examples of the aromatic group-containing monomer include phenoxyethyl (meth)acrylate, benzyl (meth)acrylate, phenyl (meth)acrylate, and a styrene-based monomer. Among these, in view of the balance between the hydrophilicity and hydrophobicity of the polymer chain and the ink fixing property, an aromatic group-containing (meth)acrylate monomer is preferred, and at least one selected from phenoxyethyl (meth)acrylate, benzyl (meth)acrylate, or phenyl (meth)acrylate is more preferred, and phenoxyethyl (meth)acrylate and benzyl (meth)acrylate are still more preferred.

The self-dispersing polymer particles in the invention preferably contain a structural unit derived from an aromatic group-containing (meth)acrylate monomer and the content thereof is preferably from 10 mass % to 95 mass %. When the content of the aromatic group-containing (meth)acrylate monomer is from 10 mass % to 95 mass %, the stability of the self-emulsified or dispersed state is improved and, further, an increase in ink viscosity can be suppressed.

In the invention, the content of the aromatic group-containing (meth)acrylate monomer is more preferably from 15 mass % to 90 mass %, further preferably from 15 mass % to 80 mass %, and particularly preferably from 25 mass % to 70 mass %, in view of the stability of the self-dispersed state, stabilization of the shape of the particles in an aqueous medium due to hydrophobic interaction between aromatic rings, and decrease in the amount of water-soluble components through appropriate hydrophobization of the particles.

The self-dispersing polymer particles in the invention may include, for example, a structural unit derived from an aromatic group-containing monomer and a structural unit derived from a dissociative group-containing monomer. The self-dispersing polymer particles may further contain other structural units as necessary.

The monomer which may be used for forming other structural units is not particularly limited so long as it is a monomer copolymerizable with the aromatic group-containing monomer and the dissociative group-containing monomer. Among these, an alkyl group-containing monomer is preferred in view of the flexibility of the polymer backbone or ease of control of the glass transition temperature (Tg).

Examples of the alkyl group-containing monomer include alkyl (meth)acrylates such as methyl (meth)acrylate, ethyl (meth)acrylate, isopropyl (meth)acrylate, n-propyl (meth)acrylate, n-butyl (meth)acrylate, isobutyl (meth)acrylate, t-butyl (meth)acrylate, hexyl (meth)acrylate, and ethylhexyl (meth)acrylate; ethylenically unsaturated monomers having a hydroxyl group such as hydroxymethyl (meth)acrylate, 2-hydroxyethyl (meth)acrylate, 2-hydroxypropyl (meth)acrylate, 4-hydroxybutyl (meth)acrylate, hydroxypentyl (meth)acrylate, and hydroxyhexyl (meth)acrylate; dialkylamino alkyl(meth)acrylates such as dimethylaminoethyl(meth)acrylate; (meth)acrylamides, for example, N-hydroxyalkyl(meth)acrylamides such as N-hydroxymethyl(meth)acrylamide, N-hydroxyethyl(meth)acrylamide, and N-hydroxybutyl(meth)acrylamide; and N-alkoxyalkyl(meth)acrylamides such as N-methoxymethyl(meth)acrylamide, N-ethoxymethyl(meth)acrylamide, N-(n-, iso)butoxymethyl(meth)acrylamide, N-methoxyethyl(meth)acrylamide, N-ethoxyethyl(meth)acrylamide, and N-(n-,iso)butoxyethyl(meth)acrylamide.

Regarding the range of the molecular weight of the water-insoluble polymer forming the self-dispersing polymer particles in the invention, the weight average molecular weight of the water-insoluble polymer is preferably from 3,000 to 200,000, more preferably from 5,000 to 150,000, and further preferably from 10,000 to 100,000. The amount of water-soluble component can be suppressed effectively by setting the weight average molecular weight to 3,000 or more. Further, self-dispersion stability can be improved by setting the weight average molecular weight to 200,000 or less.

The weight average molecular weight is measured with gel permeation chromatography (GPC). In GPC, an HLC-8020GPC (manufactured by Tosoh Corporation) is used, 3 pieces of TSKgel Super Multipore HZ-H (trade name, manufactured by Tosoh Corporation, 4.6 mm ID×15 cm) are used as the columns, and THF (tetrahydrofuran) is used as an eluent. Measurement is performed using an IR detector under the conditions of a sample concentration of 0.3 mass %, a flow rate of 0.35 mL/min, a sample injection amount of 10 μL, and a measuring temperature of 40° C. The calibration curve is prepared based on eight samples of “standard sample: TSK standard polystyrene”, which include “F-40”, “F-20”, “F-4”, “F-1”, “A-5000”, “F-2500”, “A-1000”, and “n-propylbenzene” manufactured by Tosoh Corporation.

The water-insoluble polymer forming the self-dispersing polymer particles in the invention preferably contains 15 to 80 mass % (in terms of copolymerization ratio based on the total mass of the self-dispersing polymer particles) of a structural unit derived from an aromatic group-containing (meth)acrylate monomer (preferably, a structural unit derived from phenoxyethyl (meth)acrylate and/or a structural unit derived from benzyl (meth)acrylate), in view of regulating the hydrophilicity and hydrophobicity of the polymer.

Further, the water-insoluble polymer preferably contains a structural unit derived from an aromatic group-containing (meth)acrylate monomer at a copolymerization ratio of 15 to 80 mass %, a structural unit derived from a carboxyl group-containing monomer, and a structural unit derived from an alkyl group-containing monomer (preferably, a structural unit derived from an alkyl ester of (meth)acrylic acid), in view of regulating the hydrophilicity and hydrophobicity of the polymer. The water-insoluble polymer more preferably contains a structural unit derived from phenoxyethyl(meth)acrylate and/or a structural unit derived from benzyl(meth)acrylate at a total copolymerization ratio of 15 to 80 mass %, a structural unit derived from a carboxyl group-containing monomer, and a structural unit derived from an alkyl group-containing monomer (preferably, a structural unit derived from (meth)acrylic ester of a C1 to C4 alkyl), in view of regulating the hydrophilicity and hydrophobicity of the polymer. Further, the water-insoluble polymer preferably has an acid value of from 25 to 100 and a weight average molecular weight of from 3,000 to 200,000, and more preferably has an acid value of from 25 to 95 and a weight average molecular weight of from 5,000 to 150,000, in view of regulating the hydrophilicity and hydrophobicity of the polymer.

Specific examples of the water-insoluble polymer forming the self-dispersing polymer particles include exemplary compounds B-01 to B-19 shown below. However, the invention is not limited thereto. Numerals indicated in parentheses represent the mass ratios of the copolymerization components.

B-01: phenoxyethyl acrylate/methyl methacrylate/acrylic acid copolymer (50/45/5)
B-02: phenoxyethyl acrylate/benzyl methacrylate/isobutyl methacrylate/methacrylic acid copolymer (30/35/29/6)
B-03: phenoxyethyl methacrylate/isobutyl methacrylate/methacrylic acid copolymer (50/44/6)
B-04: phenoxyethyl acrylate/methyl methacrylate/ethyl acrylate/acrylic acid copolymer (30/55/10/5)
B-05: benzyl methacrylate/isobutyl methacrylate/methacrylic acid copolymer (35/59/6)
B-06: styrene/phenoxyethyl acrylate/methyl methacrylate/acrylic acid copolymer (10/50/35/5)
B-07: benzyl acrylate/methyl methacrylate/acrylic acid copolymer (55/40/5)
B-08: phenoxyethyl methacrylate/benzyl acrylate/methacylic acid copolymer (45/47/8)
B-09: styrene/phenoxyethyl acrylate/butyl methacrylate/acrylic acid copolymer (5/48/40/7)
B-10: benzyl methacrylate/isobutyl methacrylate/cyclohexyl methacrylate/methacrylic acid copolymer (35/30/30/5)
B-11: phenoxyethyl acrylate/methyl methacrylate/butyl acrylate/methacrylic acid copolymer (12/50/30/8)
B-12: benzyl acrylate/isobutyl methacrylate/acrylic acid copolymer (93/2/5)
B-13: styrene/phenoxyethyl methacrylate/butyl acrylate/acrylic acid copolymer (50/5/20/25)
B-14: styrene/butyl acrylate/acrylic acid copolymer (62/35/3)
B-15: methyl methacrylate/phenoxyethyl acrylate/acrylic acid copolymer (45/51/4)
B-16: methyl methacrylate/phenoxyethyl acrylate/acrylic acid copolymer (45/49/6)
B-17: methyl methacrylate/phenoxyethyl acrylate/acrylic acid copolymer (45/48/7)
B-18: methyl methacrylate/phenoxyethyl acrylate/acrylic acid copolymer (45/47/8)
B-19: methyl methacrylate/phenoxyethyl acrylate/acrylic acid copolymer (45/45/10)

The method of producing a water-insoluble polymer forming the self-dispersing polymer particles in the invention is not particularly limited. Examples of the method of producing the water-insoluble polymer include a method of performing emulsion polymerization in the presence of a polymerizable surfactant so as to covalently-bond the surfactant and the water-insoluble polymer, and a method of copolymerizing a monomer mixture containing the hydrophilic group-containing monomer and the aromatic group-containing monomer by a known polymerization method such as a solution polymerization method or a bulk polymerization method. Among the polymerization methods described above, a solution polymerization method is preferred, and a solution polymerization method of using an organic solvent is more preferred, in view of aggregation speed and the stability at jetting droplets of an ink composition containing the self-dispersing polymer particles.

In view of the aggregation speed, it is preferred that the self-dispersing polymer particles in the invention contain a polymer synthesized in an organic solvent, the polymer has a carboxyl group and has an acid value of preferably from 20 to 100, some or all of the carboxyl groups of the polymer are neutralized, and the polymer is prepared as a polymer dispersion in which water constitutes the continuous phase. The self-dispersing polymer particles in the invention are prepared preferably by a method including a step of synthesizing the polymer in an organic solvent and a dispersion step of forming an aqueous dispersion in which at least some of the carboxyl groups of the polymer are neutralized.

The dispersion step preferably includes the following step (1) and step (2).

Step (1): stirring a mixture containing a polymer (water-insoluble polymer), an organic solvent, a neutralizing agent, and an aqueous medium,

Step (2): removing the organic solvent from the mixture.

Step (1) is preferably a process that includes dissolving the polymer (water-insoluble polymer) in the organic solvent and then gradually adding the neutralizing agent and the aqueous medium, and mixing and stirring these components to obtain a dispersion. By adding the neutralizing agent and the aqueous medium to the solution of the water-insoluble polymer dissolved in the organic solvent, self-dispersing polymer particles whose particle size has higher storage stability can be obtained without requiring a strong shearing force.

The stirring method for the mixture is not particularly limited, and a mixing and stirring apparatus that is used generally may be used, and optionally, a disperser such as an ultrasonic disperser or a high pressure homogenizer may be used.

Preferable examples of the organic solvent include alcohol solvents, ketone solvents and ether solvents.

Examples of the alcohol solvents include isopropyl alcohol, n-butanol, t-butanol, and ethanol. Examples of the ketone solvents include acetone, methyl ethyl ketone, diethyl ketone, and methyl isobutyl ketone. Examples of the ether solvents include dibutyl ether and dioxane. Among the solvents, ketone solvents such as methyl ethyl ketone and alcohol solvents such as isopropyl alcohol are preferred. Further, it is preferable to use isopropyl alcohol and methyl ethyl ketone in combination, with an aim of moderating the change of polarity at the phase transfer from an oil phase to an aqueous phase. By using isopropyl alcohol and methyl ethyl ketone in combination, self-dispersing polymer particles having a very small particle diameter and high dispersion stability, which does not cause precipitation by aggregation or adhesion between particles, may be obtained.

The neutralizing agent is used to neutralize some or all of the dissociative groups so that the self-dispersing polymer particles can get into a stable emulsified or dispersed state in water. When the self-dispersing polymer particles of the invention have an anionic dissociative group (for example, a carboxyl group) as a dissociative group, examples of the neutralizing agent to be used include basic compounds such as organic amine compounds, ammonia, and alkali metal hydroxides. Examples of the organic amine compounds include monomethyl amine, dimethyl amine, trimethyl amine, monoethyl amine, diethyl amine, triethyl amine, monopropyl amine, dipropyl amine, monoethanol amine, diethanol amine, triethanol amine, N,N-dimethyl-ethanol amine, N,N-diethyl-ethanol amine, 2-dimethylamino-2-methyl-1-propanol, 2-amino-2-methyl-1-propanol, N-methyldiethanol amine, N-ethyldiethanol amine, monoisopropanol amine, diisopropanol amine, and triisopropanol amine. Examples of the alkali metal hydroxides include lithium hydroxide, sodium hydroxide and potassium hydroxide. Among these, sodium hydroxide, potassium hydroxide, triethylamine, and triethanol amine are preferred in view of achieving stable dispersion of the self-dispersing polymer particles of the invention in water.

The basic compound is preferably used in an amount of from 5 to 120 mol %, more preferably from 10 to 110 mol %, and further preferably from 15 to 100 mol %, with respect to 100 mol % of the dissociative groups. When the basic compound is used in an amount of 15mol % or more, an effect of stabilizing the dispersion of the particles in water can be obtained. When the basic compound is used in an amount of 100% or less, an effect of reducing the water-soluble component can be obtained.

In Step (2), an aqueous dispersion of the self-dispersing polymer particles can be obtained by phase inversion into an aqueous phase by removing the organic solvent from the dispersion obtained in Step (1) by a common method such as distillation under reduced pressure. In the obtained aqueous dispersion, the organic solvent has been substantially removed and the amount of the organic solvent is preferably from 0.2 mass % or less and, more preferably, 0.1 mass % or less.

The volume average particle diameter of the polymer particles (particularly, self-dispersing polymer particles) is preferably in a range from 10 to 400 nm, more preferably in a range from 10 to 200 nm, further preferably in a range from 10 to 100 nm, and particularly preferably in a range from 10 to 50 nm. The production adaptability can be improved when the average particle diameter is 10 nm or more. The storage stability can be improved when the average particle diameter is 400 nm or less. The particle size distribution of the polymer particles is not particularly limited, and it may be either a wide particle size distribution or a monodisperse particle size distribution. Further, two or more kinds of water-insoluble particles may be used in the form of a mixture.

The weight average particle diameter and the particle size distribution of the polymer particles can be determined by measuring the volume average particle diameters by a dynamic light scattering method using a particle size distribution measuring apparatus NANOTRACKUPAEX150 (manufactured by Nikkiso Co. Ltd.).

The content of the polymer particles (in particular, self-dispersing polymer particles) in the ink composition is preferably from 1 to 30 mass %, and more preferably from 5 to 15 mass %, with respect to the ink composition, in view of image gloss.

One kind of the polymer particles (particularly, self-dispersing polymer particles) can be used alone, or two or more kinds of the polymer particles can be used in a mixture.

—Other additives—

The ink composition used in the invention may contain additives other than the components described above. Examples of other additives that may be used in the invention include conventional additives such as an anti-fading agent, an emulsion stabilizer, an permeation accelerator, an ultraviolet absorber, a preservative, a mildew-proofing agent, a pH regulator, an anti-foam agent, a viscosity regulator, a dispersant, a dispersion stabilizer, an anti-rust agent and a chelating agent. These various additives may be added directly after preparation of the ink composition, or may be added during the preparation of the ink composition.

Inclusion of the ultraviolet absorber improves storability of an image. Examples of the ultraviolet absorber include benzotriazole compounds such as those described in, for example, JP-A Nos. 58-185677, 61-190537, 2-782, 5-197075 and 9-34057; benzophenone compounds such as those described in, for example, JP-A Nos. 46-2784 and 5-194483, and U.S. Pat. No. 3,214,463; cinnamic acid compounds such as those described in, for example, JP-B Nos. 48-30492 and 56-21141, and JP-A No. 10-88106; triazine compounds such as those described in, for example, JP-A Nos. 4-298503, 8-53427, 8-239368, 10-182621 and 8-501291; compounds described in Research Disclosure No. 24239; and compounds that absorb ultraviolet light and then emit fluorescence, i.e., fluorescent brighteners, such as stilbene compounds or benzoxazole compounds.

An anti-fading agent is used for the purpose of improving storability of an image. Examples of the anti-fading agent that can be used include various organic anti-fading agents and metal complex anti-fading agents. Examples of organic anti-fading agents include hydroquinones, alkoxyphenols, dialkoxyphenols, phenols, anilines, amines, indanes, chromanes, alkoxyanilines and heterocycles. Examples of metal complex anti-fading agents include nickel complexes and zinc complexes. More specifically, compounds described in the patents cited in Research Disclosure No. 17643, chapter VII, items I to J; Research Disclosure No. 15162: Research Disclosure No. 18716, page 650, left-hand column; Research Disclosure No. 36544, page 527; Research Disclosure No. 307105, page 872; and Research Disclosure No. 15162, and compounds included in the formulae of the representative compounds and the exemplified compounds described on pages 127 to 137 of JP-A No. 62-215272, can be used.

Examples of the mildew-proofing agent include sodium dehydroacetate, sodium benzoate, sodium pyridinethion-1-oxide, ethyl p-hydroxybenzoate, 1,2-benzisothiazolin-3-one and salts thereof. These are preferably used in the amount of from 0.02 to 1.00% by mass with respect to the ink composition.

As the pH regulator, a neutralizer (organic base, inorganic alkali) can be used. The pH regulator may be added such that the pH of the ink composition is preferably from 6 to 10, more preferably 7 to 10, in view of improving the storage stability of the ink composition.

In view of jetting stability when the ink composition is jetted by an inkjet method and the aggregation speed at the time of contact with the reaction liquid described below, the viscosity of the ink composition in the invention is preferably in a range from 1 to 30 mPa·s, more preferably in a range from 1 to 20 mPa·s, further preferably in a range from 2 to 15 mPa·s and particularly preferably in a range from 2 to 10 mPa·s.

The viscosity of the ink composition is measured with a VISCOMETER TV-22 (manufactured by TOKI SANGYO CO., LTD.) at 25° C.

<Inkjet Image Recording Method>

The inkjet image recording method of the present invention is an inkjet image recording method that employs an ink composition and a reaction liquid that causes the ink composition to coagulate, and includes a reaction liquid application step of applying a reaction liquid including an organic acid and a water-soluble organic solvent at a content ratio of from 15 to 70 mass % relative to the organic acid and having a surface tension of at least 40 mN/m at 25° C. to a recording medium and allowing it to dry, and an ink droplet jetting step of jetting droplets of an ink composition having a surface tension of from 25 to less than 40 mN/m at 25° C. by an inkjet method onto the recording medium to which the reaction liquid has been applied.

Further, the ink droplet jetting step is preferably initiated from 0.1 seconds to within 10 seconds after the reaction liquid application step.

(Reaction Liquid Application Step)

The reaction liquid application step is a step of applying, onto a recording medium, the reaction liquid described above that can form an aggregate upon contact with the ink composition, and can be configured such that an image is visualized by contact of the ink composition and the reaction liquid. In such a case, when, for example, the reaction liquid is contacted with an ink composition containing pigment particles, the dispersion particles in the ink composition, which include the pigment particles, aggregate, and an image is fixed to the recording medium.

The specifics and preferred aspects of the reaction liquid are as described above.

Application of the reaction liquid may be performed by applying known methods such as a coating method, an inkjet method or a dipping method. The coating method may be performed by a known coating method using, for example, a bar coater, an extrusion die coater, an air doctor coater, a bread coater, a rod coater, a knife coater, a squeeze coater, or a reverse roll coater. The specifics of the inkjet method are described below.

The reaction liquid application step is provided prior to the ink droplet jetting step using the ink composition. That is, a reaction liquid for aggregating the coloring material (preferably a pigment) in the ink composition is applied in advance to the recording medium before the ink composition is jetted, and the ink composition is jetted so as to contact the reaction liquid that has been applied to the recording medium, thereby forming an image. As a result, inkjet recording can be performed at higher speed, and an image with high density and resolution can be obtained even with high-speed recording.

Further, in the present invention, a heat-drying step that dries the reaction liquid on the recording medium by heat is also provided in the interval between the end of application of the reaction liquid to the recording medium and the beginning of application of the ink composition. As a result of heat-drying of the reaction liquid in advance before the ink droplet jetting step, ink coloring properties such as prevention of bleeding are favorable and a visual image having favorable color density and hue can be recorded.

The heat-drying can be performed using a known heating means such as a heater, an dry-blowing means using air blowing such as a drier, or a means combining these. Examples of the heating method include a method of applying heat with a heater or the like from the opposite side of the recording medium to the surface on which the reaction liquid is applied, a method of applying warm or hot air to the surface of the recording medium on which the reaction liquid is applied, and a heating method using an infrared heater, and heating may be performed by combination of more than one of these methods.

(Ink Droplet Jetting Step)

In the ink droplet jetting step, the ink composition described in the foregoing is applied to the recording medium to which the reaction liquid has been applied, using an inkjet method. In this step, the ink composition can be selectively applied to the recording medium, and a desired visual image can be formed. Further, the specifics of the ink composition are as described in the foregoing.

The inkjet method is not particularly limited and may be any known system; for example, a charge control system of jetting an ink by an electrostatic attraction force; a drop on demand system of utilizing a pressure of vibration of a piezo element (pressure pulse system); an acoustic inkjet system of converting electric signals into acoustic beams, irradiating them to an ink, and jetting the ink by utilizing radiation pressure; or a thermal inkjet system of heating an ink to form bubbles and utilizing the resultant pressure (BUBBLEJET (registered trade mark)). As the inkjet method, an inkjet method is described in JP-A No. 54-59936 and can be utilized effectively; in this method, an ink is jetted from a nozzle by an acting force generated by an abrupt volume change of the ink caused by application of a thermal energy to the ink.

Examples of the inkjet method include a system of jetting a large number of small-volume ink droplets of a low concentration ink called “photo-ink”, a system of improving image quality using plural kinds of inks of substantially identical hue and of different densities, and a system of using a colorless transparent ink.

The inkjet head used in the inkjet method may either be an on-demand system head or a continuous system head. Specific examples of the jetting systems include an electric-mechanical transduction system (for example, a single-cavity system, a double-cavity system, a bender system, a piston system, a share-mode system or a shared-wall system), an electric-thermal transduction system (for example, a thermal inkjet system or a BUBBLEJET (registered trade mark) system), an electrostatic suction system (for example, an electric field control system or slit jet system), and an electric discharge system (for example, a spark-jet system). Any of these jetting systems may be used.

Ink nozzles or the like used for recording by the inkjet method are not particularly limited, and may be selected appropriately according to the purpose.

Examples of the inkjet head include an inkjet head of a shuttle system in which a short serial head is used and recording is performed while allowing the head to move in the width direction of a recording medium in a scanning manner, and an inkjet head of a line system in which a line head in which recording elements are arranged corresponding to the entire length of one side of a recording medium is used. In the line system, an image can be recorded over the entire surface of the recording medium by allowing the recording medium to be moved in a direction orthogonal to the direction in which the recording elements are arrayed, and a conveyance system such as a carriage according to which the short head moves in a scanning manner is not necessary. Further, since complicated scanning control for movement of the carriage and the recording medium is not necessary and only the recording medium is moved, higher recording speed can be attained compared with a shuttle system. While the inkjet recording method of the invention is applicable to any of these, the effect of improving the jetting accuracy and the rubbing resistance of the image is generally remarkable when the inkjet recording method is applied to the line system in which dummy jetting is not performed.

The ink droplet jetting step of the present invention is preferably initiated from 0.1 to within 10 seconds after the reaction liquid application step. This enables high-speed image recording. Further, in the inkjet image recording method of the present invention, spotting interference is suppressed and high-resolution images can be formed by using the ink set for inkjet recording described in the foregoing even when images are recorded at high speed.

Here, “initiated from 0.1 to within 10 seconds after the reaction liquid application step” means that the time period from completion of application and drying of the reaction liquid to impact of the first ink droplet on the recording medium is from 0.1 to within 10 seconds.

—Recording Medium—

The inkjet recording method of the present invention records an image onto a recording medium.

The recording medium is not particularly limited; however, general printing paper having a cellulose base such as high-quality paper, coated paper and art paper, that is, paper generally used in offset printing and the like, can be used. General printing paper having a cellulose base tends to exhibit comparatively slow absorption and drying of ink, and movement of coloring material after droplet jetting tends to occur in image recording by a general inkjet method using a water-based ink, such that image quality tends to be impaired; however, with the inkjet recording method of the present invention, movement of coloring material is suppressed and a high-quality image having excellent color density and hue can be recorded.

Recording media that are generally commercially available can be used as the recording medium, and examples include high-quality paper (A) such as Prince WOOD FREE (trade name, produced by Oji Paper Co., Ltd.), SHIRAOI (trade name, produced by Nippon Paper Industries Co., Ltd.) and New NPI High Quality (trade name, produced by Nippon Paper Industries Co., Ltd.), very light-weight coated paper such as EVER LIGHT COATED (trade name, produced by Oji Paper Co., Ltd.) and AURORA S (trade name, produced by Nippon Paper Industries Co., Ltd.), light-weight coated paper (A3) such as TOPKOTE (L) (trade name, produced by Oji Paper Co., Ltd.) and AUROA L (trade name, produced by Nippon Paper Industries Co., Ltd.), coated paper (A2, B2) such as TOPKOTE PLUS (trade name, produced by Oji Paper Co., Ltd.) and AURORA COAT (trade name, produced by Nippon Paper Industries Co., Ltd.) and art paper (A1) such as 2/SIDE GOLDEN CASK GLOSS (trade name, produced by Oji Paper Co., Ltd.) and TOKUBISHI ART (trade name, produced by Mitsubishi Paper Mills Limited). Further, different kinds of photographic paper for inkjet recording can be used.

Among these, in view of obtaining a high-quality image with more effective suppression of movement of coloring material and more favorable color density and hue than conventionally, a recording medium having a water absorption coefficient Ka of from 0.05 to 0.5 mL/m²·ms^{1/2} is preferable, a recording medium having a water absorption coefficient Ka of from 0.1 to 0.4 mL/m²·ms^{1/2} is more preferable, and a recording medium having a water absorption coefficient Ka of from 0.2 to 0.3 mL/m²·ms^{1/2} is yet more preferable.

The water absorption coefficient Ka refers to that described in the JAPAN TAPPI Paper and Pulp Testing Method No. 51: 2000 (published by JAPAN TAPPI) and, specifically, the absorption coefficient Ka is calculated from the difference between the transfer amount of water at a contact time of 100 ms and that at a contact time of 900 ms measured by an Automatic Scanning Liquid Absorptometer KM500win (manufactured by Kumagai Riki Kogyo Co., Ltd.).

In the invention, it is preferred that the amount of the reaction liquid applied and the amount of the aqueous ink applied are adjusted, as required. For example, the amount of the reaction liquid applied may be changed to adjust a physical property such as the viscoelasticity of an aggregate formed upon mixing of the reaction liquid and the aqueous ink, in accordance with the type of recording medium.

### EXAMPLES

In the following, the present invention is explained in detail using examples; however, the present invention is not limited to these examples. Further, unless specifically indicated otherwise, “parts” and “%” refer to the mass standard.

The weight average molecular weight was measured by gel permeation chromatography (GPC). In the GPC, an HLC-8020GPC (manufactured by Tosoh Corporation) was used, and 3 pieces of TSKgel Super Multipore HZ-H (manufactured by Tosoh Corporation, 4.6 mm ID×15 cm) were used as the column, and THF (tetrahydrofuran) was used as an eluent. Further, the measurement was performed using an IR detector under the conditions at a sample concentration of 0.3 mass %, a flow rate of 0.35 mL/min, a sample injection amount of 10 μL, and a measuring temperature of 40° C. The calibration curve was determined based on eight samples of “standard sample TSK: standard, polystyrene”; namely, “F-40”, “F-20”, “F-4”, “F-1”, “A-5000”, “A-2500”, “A-1000”, and “n-propylbenzene” manufactured by Tosoh Corporation.

### Example 1

˜Preparation of Ink Composition˜

[Preparation of Pigment Dispersion Liquid]

(Preparation of Polymer Dispersant P-1)

88 g of methyl ethyl ketone were added to a 1000 ml three-necked flask equipped with a stirrer and a cooling pipe and heated to 72° C. in a nitrogen atmosphere, and then a solution, in which 0.85 g of dimethyl 2,2′-azobisisobutyrate, 60 g of benzyl methacrylate, 10 g of methacrylic acid and 30 g of methyl methacrylate had been dissolved in 50 g of methyl ethyl ketone, was dripped in over three hours. After dripping, the reaction was continued for a further one hour and then a solution in which 0.42 g of dimethyl 2,2′-azobisisobutyrate had been dissolved in 2 g of methyl ethyl ketone was added, and the temperature of the resultant was raised to 78° C. and then the resultant was heated for four hours. The obtained reaction liquid was reprecipitated twice in an excessive amount of hexane and the precipitated resin was dried to give 96 g of polymer dispersant P-1.

The composition of the obtained resin was determined using a ¹H-NMR, and the weight-average molecular weight (Mw) as determined by GPC was 44,600. In addition, the acid value of the polymer as determined according to the method described in the Japanese Industrial Standards (JISK0070:1992) was found to be 65.2 mgKOH/g.

(Preparation of Cyan Dispersion Liquid)

10 parts of Pigment Blue 15:3 (phthalocyanine blue A220; produced by Dainichiseika Color & Chemicals Mfg. Co., Ltd.), 5 parts of the polymer dispersant P-1, 42 parts of methyl ethyl ketone, 5.5 parts of IN NaOH aqueous solution, and 87.2 parts of ion-exchanged water were mixed, and dispersed for from two to six hours by a bead mill using 0.1 mmφ zirconia beads.

Under reduced pressure, methyl ethyl ketone was removed from the obtained dispersion at 55° C. and, further, a part of the water was removed. The resultant was subjected to centrifugation treatment for 30 min at 8000 rpm using a high-speed centrifuge cooler 7550 (manufactured by Kubota Seisakusho) and a 50 mL centrifuge pipe, and a supernatant liquid was collected separately from deposited matter. Then, pigment density was determined from the absorbance spectrum, and a dispersion (cyan dispersion liquid) of resin-coated pigment particles (pigment coated with polymer dispersant) having a pigment density of 10.2 mass % was obtained.

(Preparation of Magenta Dispersion Liquid)

A dispersion (magenta dispersion liquid) of resin-coated pigment particles (pigment coated with polymer dispersant) was prepared in a similar manner to the preparation of the cyan dispersion liquid except that Pigment Red 122 was used instead of the Pigment Blue 15:3 (phthalocyanine blue A220; produced by Dainichiseika Color & Chemicals Mfg. Co., Ltd.) used in the preparation of the cyan dispersion liquid.

(Preparation of Yellow Dispersion Liquid)

A dispersion (yellow dispersion liquid) of resin-coated pigment particles (pigment coated with polymer dispersant) was prepared in a similar manner to the preparation of the cyan dispersion liquid except that a yellow pigment, Pigment Yellow 74, was used instead of the cyan pigment, Pigment Blue 15:3, used in the preparation of the cyan dispersion liquid.

(Preparation of Black Dispersion Liquid)

A dispersion (black dispersion liquid) of resin-coated pigment particles (pigment coated with polymer dispersant) was prepared in a similar manner to the preparation of the cyan dispersion liquid except that Carbon Black (NIPex 160-IQ, produced by Degussa AG) was used instead of the cyan pigment, Pigment Blue 15:3, used in the preparation of the cyan dispersion liquid.

(Preparation of Self-Dispersing Polymer Particles)

360.0 g of methyl ethyl ketone was placed in a two-liter three-necked flask equipped with a stirrer, a thermometer, a reflux cooling pipe and a pipe for introduction of nitrogen gas, and heated to 75° C. The temperature inside the reaction vessel was maintained at 75° C. and a mixed solution of 180.0 g of phenoxyethyl acrylate, 162.0 g of methyl methacrylate, 18.0 g of acrylic acid, 72 g of methyl ethyl ketone and 1.44 g of V-601 (trade name, produced by Wako Pure Chemical Industries, Ltd.) was dripped in at constant speed such that the dripping was completed in two hours. After completion of dripping, a solution of 0.72 g of V-601 and 36.0 g of methyl ethyl ketone was added. Then, after stirring at 75° C. for two hours, a further solution of 0.72 g of V-601 and 36.0 g of isopropanol was added and, after stirring at 75° C. for two hours, the temperature was raised to 85° C. The stirring was continued for further two hours. The weight-average molecular weight (Mw) of the obtained copolymer was 64,000 (calculated as polystyrene-equivalency by Gel Permeation Chromatography (GPC), columns used: TSKgel SuperHZM-H, TSKgel SuperHZ4000 and TSKgel SuperHZ200 (manufactured by Tosoh Corporation)) and the acid value was found to be 38.9 (mgKOH/g).

Next, 668.3 g of the polymer solution was weighed, 388.3 g of isopropanol and 145.7 ml of 1 mol/L NaOH aqueous solution were added, and the temperature inside the reaction vessel was raised to 80° C. Next, 720.1 g of distilled water were dripped in at a rate of 20 ml/min and the resultant was water-dispersed. Then, after the temperature inside the reaction vessel had been maintained at 80° C. for two hours, 85° C. for two hours, and 90° C. for two hours at atmospheric pressure, the pressure inside the reaction vessel was reduced and a total of 913.7 g of isopropanol, methyl ethyl ketone and distilled water were removed to provide a water dispersion (emulsion) of self-dispersing polymer fine particles (B-01) having a solid content density of 28.0%.

<Preparation of Ink Composition>

Respective ink compositions were prepared using the pigment dispersion liquids of the respective colors and the self-dispersing polymer fine particles obtained above and by mixing the respective components shown in the following Table 1 so as to give the ink compositions (solid content) shown therein. The prepared ink compositions were filtered through a PVDF 5 μm filter (Millex SV; diameter: 25 mm; produced by Millipore Corporation) in a disposable plastic syringe to provide finished ink compositions.

The pH (25° C.) of the ink compositions of the respective colors was measured using a pH meter WM-50EG produced by DKK-TOA Corporation. Further, the surface tension at 25° C. was measured using a FASE Automatic Surface Tensionmeter CBVP-Z (manufactured by Kyowa Interface Science Co., Ltd.). The results are shown in Table 1.

TABLE 1

| Ink composition | C1 | M1 | Y1 | K1 |
|---|---|---|---|---|
| Cyan pigment (using cyan dispersion liquid) | 4 | — | — | — |
| Magenta pigment (using magenta dispersion | — | 4 | — | — |
| liquid) | | | | |
| Yellow pigment (using yellow dispersion | — | — | 4 | — |
| liquid) | | | | |
| Black pigment (using black dispersion | — | — | — | 4 |
| liquid) | | | | |
| Pigment dispersant | 2 | 2 | 2 | 2 |
| SUNNIX (NEWPOL) GP-250¹ | 10 | 10 | 10 | 10 |
| Tripropylene glycol monomethyl ether | 5 | 5 | 5 | 5 |
| OLEFIN E1010² | 1 | 1 | 1 | 1 |
| Self-dispersing polymer particles | 4 | 4 | 4 | 4 |
| Water | 74 | 74 | 74 | 74 |
| pH | 8.7 | 8.6 | 8.4 | 8.5 |
| Surface Tension (mN/m) | 34.6 | 35.2 | 35.1 | 34.8 |

¹Produced by Sanyo Chemical Industries, Ltd.
²Produced by Nisshin Chemical Industry Co., Ltd.

[Preparation of Reaction Liquid]

(Reaction Liquid 1)

Reaction Liquid 1 was prepared by mixing the following materials.
Maleic acid: 5 g
Anionic surfactant A (10%): 0.01 g
Diethylene glycol monoethyl ether: 20 g
Ion-exchanged water: added so as to provide a total of 100 g

Further, anionic surfactant A is a compound represented by the following formula.

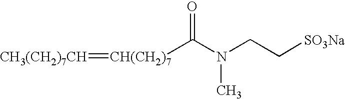

The pH of the obtained Reaction Liquid 1 was measured using a pH meter WM-50EG produced by DKK-TOA Corporation, and the pH at 25° C. was 1.89. Further, the surface tension at 25° C. was measured using a FASE Automatic Surface Tensionmeter CBVP-Z (manufactured by Kyowa Interface Science Co., Ltd.), and was 43.5 mN/m.

(Preparation of Reaction Liquids 2-25)

Reaction Liquids 2-25 were prepared in a similar manner to the preparation of Reaction Liquid 1, except that the type and amount added of the organic acid and the water-soluble organic solvent in the preparation of Reaction Liquid 1 were changed to the compositions shown in the following Table 2, and the amount of anionic surfactant added was adjusted appropriately such that the surface tension of the reaction liquid was from 40 to 50 mN/m.

<Inkjet Image Recording>

Using TOKUBISHI ART (produced by Mitsubishi Paper Mills Limited), size A4, as the recording medium, and using the above-described inks and reaction liquids, image recording was performed under the following image recording conditions.

Further, ink droplet jetting was initiated one second or longer after the reaction liquid application step.

—Reaction Liquid Application Step—

The reaction liquid shown in Table 2 was applied as a coat to the surface of the recording medium at an application amount of 1.7 g/m² using a coating bar, immediately prior to ink recording on the medium.

Next, the recording medium to which the reaction liquid had been applied was dried under the following conditions.

—Reaction Liquid Drying Conditions (Air Blow Drying)—

Blow speed: 15 m/s

Temperature: heating was conducted from the reverse surface of the recording medium recording surface using a contact planar heater such that the surface temperature of the recording medium reached 60° C.

Air-blow region: 450 mm (drying time: 0.7 seconds)

—Ink Droplet Jetting Step—

Using cyan pigment ink C1, magenta pigment ink M1, yellow pigment ink Y1, and black pigment ink K1 obtained as described above as the ink composition, four-color single-pass image formation was performed under the following conditions. The order of droplet jetting of the respective color inks was M1-K1-C1-Y1.

The ink composition was applied to the recording medium to which the reaction liquid had been applied, under the following conditions.

Head: 1,200 dpi/20 inch-width piezo full-line heads arrayed, one for each color

Jetting liquid droplet amount: 2.4 pL recording

Driving frequency: 30 kHz (recording medium conveyance speed: 635 mm/sec)

Next, the recording medium to which the ink had been applied was dried under the following conditions. —Ink Drying Conditions (Air Blow Drying)—

Blow speed: 15 m/s

Temperature: heating was conducted from the reverse surface of the recording medium recording surface using a contact planar heater such that the surface temperature of the recording medium reached 60° C.

Air-blow region: 640 mm (drying time: 1 second)

Next, heat-fixing processing was performed under the following conditions and samples were prepared having images formed on the recording medium.

—Fixing—

Silicon rubber roller (hardness: 50°; nip width: 5 mm)

Roller temperature: 90° C.

Pressure: 0.8 MPa

<Evaluation>

### 1. Evaluation of Quality of Reaction Liquid Coating Surface

1 g of the above magenta pigment ink M1 was added per 100 g of the reaction liquid prepared above to provide a colored solution, this reaction liquid was coated on the recording medium (under the same conditions as in the above reaction liquid application step), and the quality of the coating surface was observed visually and evaluated according to the following evaluation criteria. The evaluation results are shown in the following Table 2.

˜Evaluation Criteria˜

A: Uniform overall with no variations in color density.

B: Stripes of density gradation slightly observed, but uniform overall and at an acceptable level for practical application.

C: Striped density variation and partial spotted variation observed; problematic for practical application.

### 2. Blank Portion Gloss

The gloss at blank portions on which ink droplets had not been jetted on the above image-recorded sample was measured at an angle of incidence of 60° using a HORIBA GLOSS CHECKER IG-331 (tradename) and evaluated according to the following evaluation criteria. The evaluation results are shown in the following Table 2.

˜Evaluation Criteria˜

A: In a range of less than ±3% relative to the gloss of recording medium that had not been coated with the reaction liquid.

B: In a range of ±3 to less than 5% relative to the gloss of recording medium that had not been coated with the reaction liquid, the difference being barely perceptible at a threshold level of perception.

C: In a range of ±5% or more relative to the gloss of recording medium that had not been coated with the reaction liquid, the contrast with the non-coated portion being clearly evident.

### 3. Spotting Interference

In the process of forming an image, ink droplets of different colors to be spotted adjacently and with partial overlap were alternately spotted one drop at a time (one after another) with a given time lag. The time for a previously spotted droplet to coagulate was evaluated. The image was observed with an optical microscope and when the previously spotted droplet mixed with the subsequently spotted droplet, it was determined that the previously spotted droplet had not yet coagulated. The time required before the previously spotted droplet did not mix with the subsequently jetted droplet was determined as a spotting interference time period. The spotting interference time period was evaluated in accordance with the following criteria, and the results are shown in the following Table 2.

˜Evaluation Criteria˜

A: The previously spotted droplet solidified less than 20 ms (after the spotting) and no mixing with an adjacent droplet was observed.

B: The previously spotted droplet solidified in from 20 ms to less than 100 ms. Slight mixing with an adjacent droplet was observed, but the extent of mixing was acceptable for practical application.

C: The previously spotted droplet solidified in 100 ms or more. There was significant color mixing with an adjacent droplet and color irregularity that was problematic for practical applications.

### 4. Evaluation of Scratch Resistance of Printed Image

An image recording medium on which an image had been printed and dried was left to stand in ambient temperature and humidity conditions for one day. Then, another sheet of the image recording medium, which had no printed image, was placed over the image-bearing surface of the printed image recording medium, and rubbed thereagainst ten times with a load of 240 g/cm². The vulnerability of the printed image was observed and evaluated according to the following criteria. The results of the evaluation are shown in the following Table 2.

˜Evaluation Criteria˜

A: No difference was observed between a rubbed portion and a non-rubbed portion. The rubbed portion had no scratches.

B: Practically non-problematic. No damage was observed in a printed image, although the surface of the rubbed portion was slightly scratched.

C: Minimum tolerable level for practical application. The ink of the rubbed portion was slightly erased, and very small scratches were observed in the rubbed portion.

D: Practically problematic. Ink in a rubbed portion was erased, and the blank background of the image recording medium was partly exposed in the rubbed portion.

TABLE 2

| | | | | | Water- | | | | | | | |
|---|---|---|---|---|---|---|---|---|---|---|---|---|
| | | | | | soluble | | | | | | | |
| | Organic Acid | | Water-soluble | | Organic | | | | | | | |
| | | Content | Organic Solvent | | Solvent/ | Surface | | Coating | Blank | | | |
| | | Ratio | | Content | Organic | Tension | | Surface | Portion | Spotting | Scratch | |
| | Type | (%) | Type | Ratio (%) | Acid | (mN/m) | pH | Quality | Gloss | Interference | Resistance | Note |
| Reaction | Maleic Acid | 5 | DEGmEE | 20 | 4.0 | 42.1 | 1.06 | A | C | C | D | Comparison |
| Liquid 1 | | | | | | | | | | | | |
| Reaction | Maleic Acid | 10 | TPGmME | 20 | 2.0 | 43.1 | 0.97 | A | C | C | D | Comparison |
| Liquid 2 | | | | | | | | | | | | |
| Reaction | Maleic Acid | 10 | TPGmME | 5 | 0.50 | 42.8 | 0.97 | A | A | B | A | Present |
| Liquid 3 | | | | | | | | | | | | Invention |
| Reaction | Maleic Acid | 15 | TPGmME | 5 | 0.33 | 43.2 | 0.82 | A | A | A | A | Present |
| Liquid 4 | | | | | | | | | | | | Invention |
| Reaction | Maleic Acid | 15 | TPGmME | 10 | 0.67 | 43.5 | 0.83 | A | A | A | A | Present |
| Liquid 5 | | | | | | | | | | | | Invention |
| Reaction | Maleic Acid | 15 | TPGmME | 20 | 1.33 | 44.6 | 0.82 | A | C | B | D | Comparison |
| Liquid 6 | | | | | | | | | | | | |
| Reaction | Maleic Acid | 20 | TPGmME | 2.5 | 0.125 | 42.7 | 0.66 | B | A | A | C | Comparison |
| Liquid 7 | | | | | | | | | | | | |
| Reaction | Maleic Acid | 20 | TPGmME | 5 | 0.25 | 42.8 | 0.65 | A | A | A | A | Present |
| Liquid 8 | | | | | | | | | | | | Invention |
| Reaction | Maleic Acid | 20 | TEGmME | 10 | 0.50 | 44.2 | 0.65 | A | A | A | A | Present |
| Liquid 9 | | | | | | | | | | | | Invention |
| Reaction | Maleic Acid | 25 | TEGmME | 20 | 0.80 | 42.1 | 0.56 | A | B | A | D | Comparison |
| Liquid 10 | | | | | | | | | | | | |
| Reaction | Maleic Acid | 25 | TEGmME | 5 | 0.20 | 45.8 | 0.56 | A | A | A | C | Present |
| Liquid 11 | | | | | | | | | | | | Invention |
| Reaction | Maleic Acid | 25 | TEGmME | 10 | 0.40 | 43.7 | 0.56 | A | A | A | A | Present |
| Liquid 12 | | | | | | | | | | | | Invention |
| Reaction | Maleic Acid | 30 | TEGmME | 10 | 0.33 | 43.0 | 0.45 | A | A | A | A | Present |
| Liquid 13 | | | | | | | | | | | | Invention |
| Reaction | Maleic Acid | 35 | TEGmME | 20 | 0.57 | 43.2 | 0.39 | A | B | A | B | Present |
| Liquid 14 | | | | | | | | | | | | Invention |
| Reaction | Maleic Acid | 35 | TEGmME | 27 | 0.77 | 43.8 | 0.39 | B | C | A | D | Comparison |
| Liquid 15 | | | | | | | | | | | | |
| Reaction | Malonic Acid | 25 | TEGmME | 10 | 0.40 | 42.8 | 0.56 | A | A | A | A | Present |
| Liquid 16 | | | | | | | | | | | | Invention |
| Reaction | DL-Malic Acid | 25 | DEGmBE | 5 | 0.40 | 43.2 | 1.30 | A | A | A | A | Present |
| Liquid 17 | | | TEGmME | 5 | | | | | | | | Invention |
| Reaction | Tartaric Acid | 25 | DEGmBE | 5 | 0.40 | 43.2 | 1.08 | A | A | A | A | Present |
| Liquid 18 | | | DPG | 5 | | | | | | | | Invention |
| Reaction | 4-methyl | 12.5 | PE-62 | 5 | 0.40 | 43.9 | 0.85 | A | A | A | A | Present |
| Liquid 19 | Phthalic Acid, | 12.5 | GP-250 | 5 | | | | | | | | Invention |
| | Maleic Acid | | | | | | | | | | | |
| Reaction | DL-Malic Acid, | 12.5 | TPGmME | 10 | 0.40 | 44.5 | 0.77 | A | A | A | A | Present |
| Liquid 20 | Maleic Acid | 12.5 | | | | | | | | | | Invention |
| Reaction | Maleic Acid | 25 | DEGmBE | 5 | 0.20 | 42.4 | 0.57 | A | A | A | B | Present |
| Liquid 21 | | | | | | | | | | | | Invention |
| Reaction | Maleic Acid | 25 | DPG | 10 | 0.40 | 43.4 | 0.56 | A | A | A | A | Present |
| Liquid 22 | | | | | | | | | | | | Invention |
| Reaction | Maleic Acid | 25 | TPGmME | 10 | 0.40 | 43.7 | 0.57 | A | A | A | A | Present |
| Liquid 23 | | | | | | | | | | | | Invention |
| Reaction | Maleic Acid | 25 | GP-250 | 10 | 0.40 | 43.6 | 0.56 | A | A | A | A | Present |
| Liquid 24 | | | | | | | | | | | | Invention |
| Reaction | Maleic Acid | 25 | PE-62 | 10 | 0.40 | 42.9 | 0.56 | A | A | A | A | Present |
| Liquid 25 | | | | | | | | | | | | Invention |

The abbreviations for the kind of water-soluble organic solvent in the table indicate the following.

DEGmEE: diethylene glycol monoethyl ether

DEGmBE: diethylene glycol monobutyl ether

TEGmME: triethylene glycol monomethyl ether

DPG: dipropylene glycol

TPGmME: tripropylene glycol monomethyl ether

GP-250: polyoxypropylene glyceryl ether (produced by Sanyo Chemical Industries, Ltd.; NEWPOL GP-250)

PE-62: polyoxyethylene polyoxypropylene glycol (produced by Sanyo Chemical Industries, Ltd.; NEWPOL PE-62)

It is evident from the results in Table 2 that blank portion gloss and scratch resistance deteriorated in the comparative samples in which the content ratio (water-soluble organic solvent/organic acid) in the reaction liquid exceeded 0.7. Further, in the comparative examples in which the content ratio (water-soluble organic solvent/organic acid) was less than 0.15, deterioration of scratch resistance was observed. On the other hand, in the present invention, favorable results for the respective properties were obtained.

### Example 2

(Preparation of Reaction Liquid)

Reaction Liquids 30, 31 and 32 were respectively prepared in a similar manner to the preparation of Reaction Liquids 9, 10 and 12 in Example 1, except that the amount of surfactant added was modified appropriately so as to give the surface tension values shown in the following Table 3. Curling was evaluated by the following method using these reaction liquids.

### 5. Curling Evaluation

A recording medium to which reaction liquid has been applied and dried in the same manner as in the above reaction liquid application step is cut into sample pieces having a size of 50 mm×5 mm relative to the MD and CD directions, respectively, and ink composition C1 is jetted thereon in an amount of 10 g/m² to record a solid image. After image recording, the degree of curling after eight hours at 23° C. and 60% RH is measured in accordance with the curling curvature measurement method stipulated in the JAPAN TAPPI Paper and Pulp Testing Method No. 15-2: 2000, and evaluated according to the following criteria. The results of the evaluation are shown in the following Table 3.

˜Evaluation Criteria˜

A: The degree of curling was less than 10.

B: The degree of curling was from 10 to less than 20.

C: The degree of curling was from 20 to less than 30.

D: The degree of curling was 30 or more.

TABLE 3

| | | | Water-soluble Organic | | | | | | |
|---|---|---|---|---|---|---|---|---|---|
| | Organic Acid | | Solvent | | Water-soluble | Surface | | | |
| | | Content | | Content | Organic Solvent/ | Tension | | | |
| | Type | Ratio (%) | Type | Ratio (%) | Organic Acid | (mN/m) | pH | Curling | Note |
| Reaction | Maleic | 20 | TEGmME | 10 | 0.50 | 44.2 | 0.65 | A | Present Invention |
| Liquid 9 | Acid | | | | | | | | |
| Reaction | Maleic | 25 | TEGmME | 20 | 0.80 | 42.1 | 0.56 | C | Comparison |
| Liquid 10 | Acid | | | | | | | | |
| Reaction | Maleic | 25 | TEGmME | 10 | 0.40 | 43.7 | 0.56 | A | Present Invention |
| Liquid 12 | Acid | | | | | | | | |
| Reaction | Maleic | 20 | TEGmME | 10 | 0.50 | 36.7 | 0.66 | C | Comparison |
| Liquid 30 | Acid | | | | | | | | |
| Reaction | Maleic | 25 | TEGmME | 20 | 0.80 | 36.8 | 0.56 | D | Comparison |
| Liquid 31 | Acid | | | | | | | | |
| Reaction | Maleic | 25 | TEGmME | 10 | 0.40 | 36.5 | 0.57 | C | Comparison |
| Liquid 32 | Acid | | | | | | | | |

It is evident from Table 3 that the degree of curling was favorable when the reaction liquid of the present invention was used. However, it is evident that when Reaction Liquid 10 was used, in which the content ratio (water-soluble organic solvent/organic acid) exceeds 0.70, and when the surface tension of the reaction liquid was less than 40 mN/m, the degree of curling was increased.

### Example 3

(Preparation of Reaction Liquid)

Respective reaction liquids were prepared in a similar manner to the preparation of Reaction Liquids 8, 17 and 20 in Example 1, except that the surfactant was changed to EMALGEN 109E (nonionic surfactant; produced by KAO Corporation) and, when subjected to the same evaluations as in Example 1, each exhibited favorable results similarly to the present invention in Example 1.

According to the present invention, an ink set for inkjet recording having excellent blank portion gloss and image scratch resistance and reduced spotting interference, and an inkjet recording method using the same, can be provided.

Embodiments of the present invention are described below; however, the present invention is not limited thereto.

<1> An ink set for inkjet recording, comprising:an ink composition having a surface tension of from 25 to less than 40 mN/m at 25° C.; and a reaction liquid having a surface tension of 40 mN/m or more at 25° C. and comprising an organic acid and a water-soluble organic solvent that is present at a content ratio of 0.15 to 0.70 relative to the organic acid.

<2> The ink set for inkjet recording of <1>, wherein the organic acid includes an organic carboxylic acid at an amount of 10 to 35 mass % with respect to the reaction liquid.

<3> The ink set for inkjet recording of <1> or <2>, wherein the organic acid includes an organic carboxylic acid at an amount of 15 to 30 mass % with respect to the reaction liquid.

<4> The ink set for inkjet recording any one of <1> to <3>, wherein the organic carboxylic acid is a divalent or higher polyvalent carboxylic acid.

<5> The ink set for inkjet recording any one of <1> to <4>, wherein the pH of the reaction liquid is 3.5 or less.

<6> The ink set for inkjet recording any one of <1> to <5>, wherein the pH of the reaction liquid is from 0.5 to 2.5.

<7> The ink set for inkjet recording any one of <1> to <6>, wherein the surface tension of the reaction liquid at 25° C. is from 42 to 50 mN/m.

<8> The ink set for inkjet recording any one of <1> to <7>, wherein the reaction liquid comprises from 3 to 20 mass % of the water-soluble organic solvent.

<9> The ink set for inkjet recording any one of <1> to <8>, wherein the reaction liquid comprises from 5 to 15 mass % of the water-soluble organic solvent.

<10> The ink set for inkjet recording any one of <1> to <9>, wherein the reaction liquid further comprises an anionic surfactant or a nonionic surfactant.

<11> An inkjet image recording method, comprising: applying a reaction liquid having a surface tension of 40 mN/m or more at 25° C. and comprising an organic acid and a water-soluble organic solvent that is present at a content ratio of 0.15 to 0.70 relative to the organic acid onto a recording medium; drying the reaction liquid; and jetting ink droplets of an ink composition having a surface tension of from 25 to less than 40 mN/m at 25° C. onto the recording medium onto which the reaction liquid has been applied using an inkjet method.

<12> The inkjet image recording method of <11>, wherein the jetting of ink droplets is initiated from 0.1 to within 10 seconds after the applying and drying of the reaction liquid.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink set for inkjet recording, comprising:
an ink composition having a surface tension of from 25 to less than 40 mN/m at 25° C.; and
a reaction liquid having a surface tension of 40 mN/m or more at 25° C. and comprising an organic acid and a water-soluble organic solvent that is present at a content ratio of 0.15 to 0.70 relative to the organic acid.

2. The ink set for inkjet recording of claim 1, wherein the organic acid includes an organic carboxylic acid at an amount of 10 to 35 mass % with respect to the reaction liquid.

3. The ink set for inkjet recording of claim 1, wherein the organic acid includes an organic carboxylic acid at an amount of 15 to 30 mass % with respect to the reaction liquid.

4. The ink set for inkjet recording of claim 2, wherein the organic carboxylic acid is a divalent or higher polyvalent carboxylic acid.

5. The ink set for inkjet recording of claim 1, wherein the pH of the reaction liquid is 3.5 or less.

6. The ink set for inkjet recording of claim 1, wherein the pH of the reaction liquid is from 0.5 to 2.5.

7. The ink set for inkjet recording of claim 1, wherein the surface tension of the reaction liquid at 25° C. is from 42 to 50 mN/m.

8. The ink set for inkjet recording of claim 1, wherein the reaction liquid comprises from 3 to 20 mass % of the water-soluble organic solvent.

9. The ink set for inkjet recording of claim 1, wherein the reaction liquid comprises from 5 to 15 mass % of the water-soluble organic solvent.

10. The ink set for inkjet recording of claim 1, wherein the reaction liquid further comprises an anionic surfactant or a nonionic surfactant.

11. An inkjet image recording method, comprising:
applying a reaction liquid having a surface tension of 40 mN/m or more at 25° C. and comprising an organic acid and a water-soluble organic solvent that is present at a content ratio of 0.15 to 0.70 relative to the organic acid onto a recording medium;
drying the reaction liquid; and
jetting ink droplets of an ink composition having a surface tension of from 25 to less than 40 mN/m at 25° C. onto the recording medium onto which the reaction liquid has been applied, using an inkjet method.

12. The inkjet image recording method of claim 11, wherein the jetting of ink droplets is initiated from 0.1 to within 10 seconds after the applying and drying of the reaction liquid.
